(19) United States
(12) Patent Application Publication
(10) Pub. No.: US 2019/0306155 A1
(43) Pub. Date: Oct. 3, 2019

(54) GENERATING CRYPTOGRAPHIC KEYS USING SUPPLEMENTAL AUTHENTICATION DATA

(71) Applicant: CA, Inc., New York, NY (US)

(72) Inventors: Dhiraj Girdhar, Westborough, MA (US); Sandeep Kumar Ramnani, Shrewsbury, MA (US)

(21) Appl. No.: 15/939,075

(22) Filed: Mar. 28, 2018

(51) Int. Cl. H04L 29/06; H04L 9/32; H04L 9/08

(52) U.S. Cl. CPC H04L 63/0838; H04L 63/0884; H04L 63/0846; H04L 9/0891; H04L 9/0866; H04L 9/3228

(57) ABSTRACT

Techniques are disclosed relating to generating cryptographic keys using supplemental authentication data for use in user authentication. In one embodiment, an authentication application executing on a computing device may access an initial cryptographic key that is shared with an authentication server configured to authenticate a user of the computing device to a service provided by a server system. The authentication application may execute a routine to obtain a supplemental authentication data value that is not stored by the computing device prior to executing the routine. Further, the authentication application may generate an updated cryptographic key based on the initial cryptographic key and the supplemental authentication data value. In some embodiments, the authentication application may use the updated cryptographic key to generate a one-time passcode that, when communicated to an authentication server, is usable to authenticate the user to the service.

### BACKGROUND

### Technical Field

This disclosure relates generally to user authentication, and more particularly to generating cryptographic keys using supplemental authentication data for use in user authentication.

### Description of the Related Art

Server systems, such as web server systems, application server systems, etc., may provide various computing resources to an end user. For example, an application server may provide access to software applications to various end users. The server system may limit access to its resources to only authorized end users. One method of limiting access is to require end users to provide credentials, such as a username and password, to the server system, which the server system may use to authenticate the requesting end user prior to providing access to the resource. In some instances, however, the use of such credentials may be susceptible to various vulnerabilities (e.g., phishing attacks), presenting security concerns. Thus, in various instances, it may be desirable to utilize secondary user authentication techniques.

### SUMMARY

Techniques are disclosed relating to generating cryptographic keys using supplemental authentication data for use in user authentication. In one embodiment, an authentication application executing on a computing device may access an initial cryptographic key that is shared with an authentication server configured to authenticate a user of the computing device to a service provided by a server system. The authentication application may execute a routine to obtain a supplemental authentication data value that is not stored by the computing device prior to executing the routine. For example, in one embodiment, executing the routine to obtain the supplemental authentication data value may include determining one or more device attributes associated with the computing device and performing a cryptographic function on a string that specifies the one or more device attributes to obtain the supplemental authentication data value. In another embodiment, for example, executing the routine to obtain the supplemental authentication data value may include receiving user input indicative of a user-provided password, and performing a cryptographic function on the user-provided password to generate the supplemental authentication data value. Further, the authentication application may generate an updated cryptographic key based on the initial cryptographic key and the supplemental authentication data value. In some embodiments, the authentication application may use the updated cryptographic key to generate a one-time passcode that, when communicated to an authentication server, may be usable to authenticate the user to the service.

### BRIEF DESCRIPTION OF THE DRAWINGS

FIG. 1 is a block diagram illustrating an example system for authenticating an end user to a server system by generating cryptographic keys using supplemental authentication data, according to some embodiments.

FIGS. 2A and 2B are block diagrams illustrating example authentication applications, according to some embodiments.

FIG. 3 is a block diagram illustrating an example authentication system, according to some embodiments.

FIG. 4 is a flow diagram illustrating an example method for generating a cryptographic key using supplemental authentication data, according to some embodiments.

FIGS. 5A and 5B are flow diagrams illustrating example methods for executing a routine to obtain supplemental authentication data values, according to some embodiments.

FIG. 6 is a block diagram illustrating an example computer system, according to some embodiments.

### DETAILED DESCRIPTION

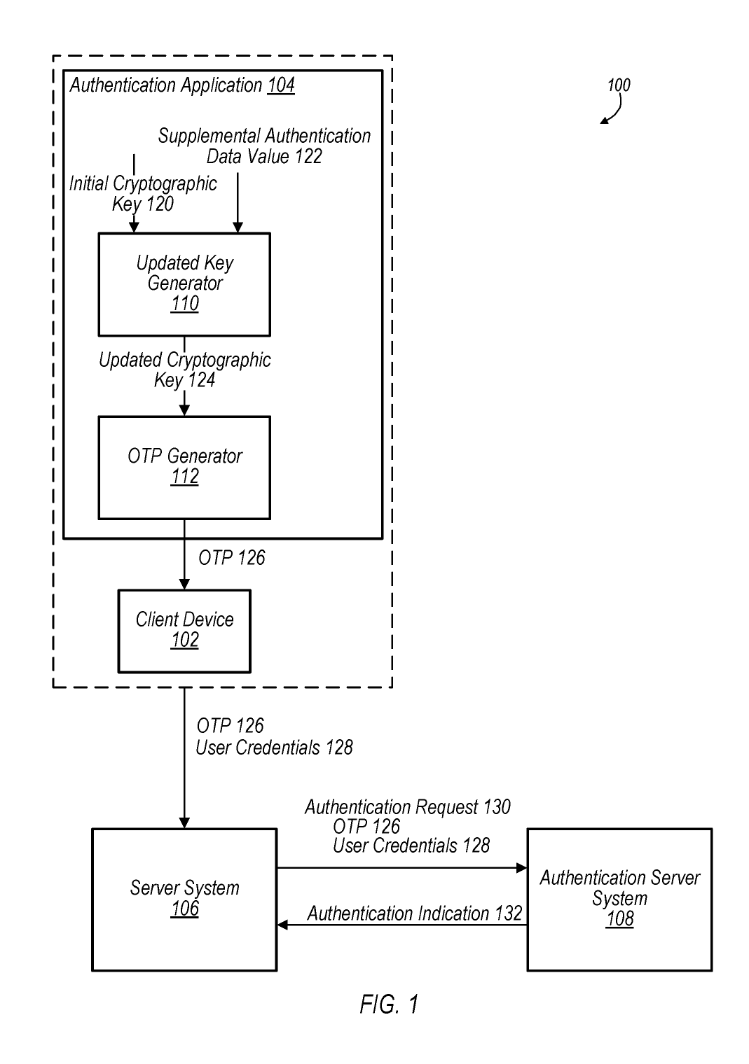

Referring to FIG. 1, a block diagram illustrating a system 100 for authenticating an end user to a server system is depicted, according to some embodiments. In the embodiment of FIG. 1, system 100 includes client device 102, server system 106, and authentication server system 108. Note that, although shown in direct connection, one or more of client device 102, authentication application 104, server system 106, or authentication server system 108 may be connected via one or more communication networks (not shown for clarity).

In various embodiments, server system 106 may be configured to provide services (e.g., software applications, email services, etc.) to various users, such as a user of client device 102. In various instances, server system 106 may limit access to the services it provides only to authorized users (e.g., to protect sensitive data, etc.). A server system may limit access to its services according to various techniques. For example, a server system may require that a user provide valid user credentials (e.g., username, password, PIN code, etc.) to access its services. Such a single, “knowledge-based” authentication factor, however, may present various shortcomings. For example, in the event that a user's credentials are compromised (e.g., through a phishing attack), an unauthorized user may then be able to access the service to the same extent as the authorized user, thus exposing potentially sensitive information and functionality to the unauthorized user.

In some instances, a server system may implement a multi-factor authentication scheme to protect access to the computing resources it provides. For example, in addition to a knowledge-based authentication factor, a server computer system may require a second, “possession-based” authentication factor also be satisfied, e.g., by the user demonstrating that they are in possession of something that they (and only they) have, before authorizing a user to access its services. One such possession-based authentication factor includes having the user provide, to the authenticating entity, authentication information generated by an authentication application installed on a verified client device (e.g., a smartphone, laptop, etc.). In such instances, the authentication application and authentication system may utilize corresponding cryptographic keys (or simply “keys”) as part of a cryptographic scheme used to authenticate the user of the client device to the service provided by the server system. For example, in some embodiments, an authentication application and authentication system may implement a symmetric-key encryption scheme in which both entities maintain a shared, secret cryptographic key. During authentication, the authentication application may use that shared cryptographic key to generate authentication information, such as a one-time passcode (“OTP”), which may be sent to the server system (or a third-party system) for authentication. The authentication system may then generate a corresponding OTP and compare. If the OTP received from the authentication application matches the OTP generated by the authentication system, the authentication system may determine that the requesting user is in possession of the verified client device, satisfying the possession-based authentication factor. If both the knowledge-based and possession-based authentication factors are satisfied, the authentication system may authenticate the user to the service.

Such an approach, however, also suffers from various shortcomings. For example, in the event that the shared, secret cryptographic key is compromised by an unauthorized user (e.g., through malware present on the client device), the unauthorized user may use the cryptographic key to generate OTPs. If an unauthorized user is able to obtain both user credentials and such a cryptographic key used to generate OTPs, the unauthorized user may use this information to pose as the authorized user and access the service provided by the server system.

In at least some embodiments, the disclosed systems and methods may mitigate these or other shortcomings by using an updated cryptographic key (which is not retained by the client device for future usage) to generate the OTPs. Stated differently, disclosed embodiments include generating, at the time of authentication, an updated cryptographic key based on a shared cryptographic key and supplemental authentication data. That updated cryptographic key may then be used to generate one or more OTPs to authenticate the user to the service. As will be discussed in more detail below, such embodiments may present various advantages. For example, in such embodiments, it is the shared cryptographic key that is retained by the client device—not the updated cryptographic key used to generate the OTPs. Accordingly, even if an unauthorized user were to acquire the shared cryptographic key, that unauthorized user would still be unable to successfully pose as the authorized user because the shared cryptographic key, alone, cannot generate valid OTPs.

Referring again to the embodiment depicted in FIG. 1, a user of client device 102 may attempt to access a service provided by server system 106. As noted above, server system 106 may limit access to the services it provides to only authorized users. Thus, in various embodiments, server system 106 may require that a user of client device 102 provide both user credentials 128 and a valid OTP 126 before the user may access the service provided by server system 106.

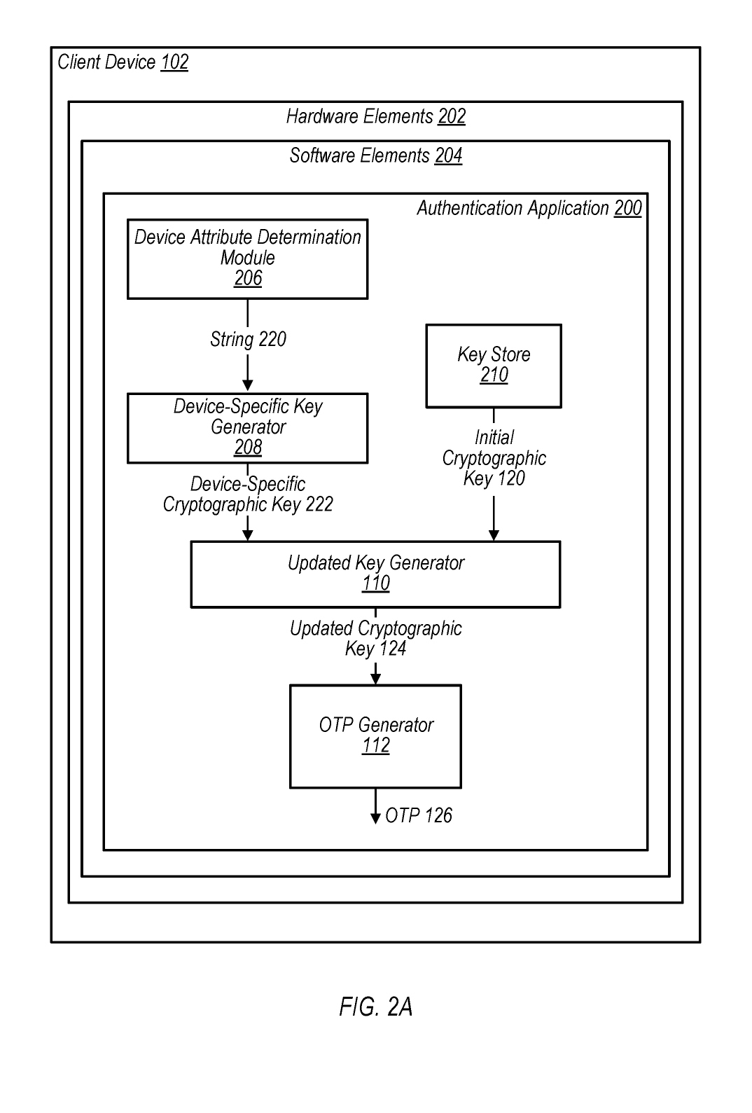

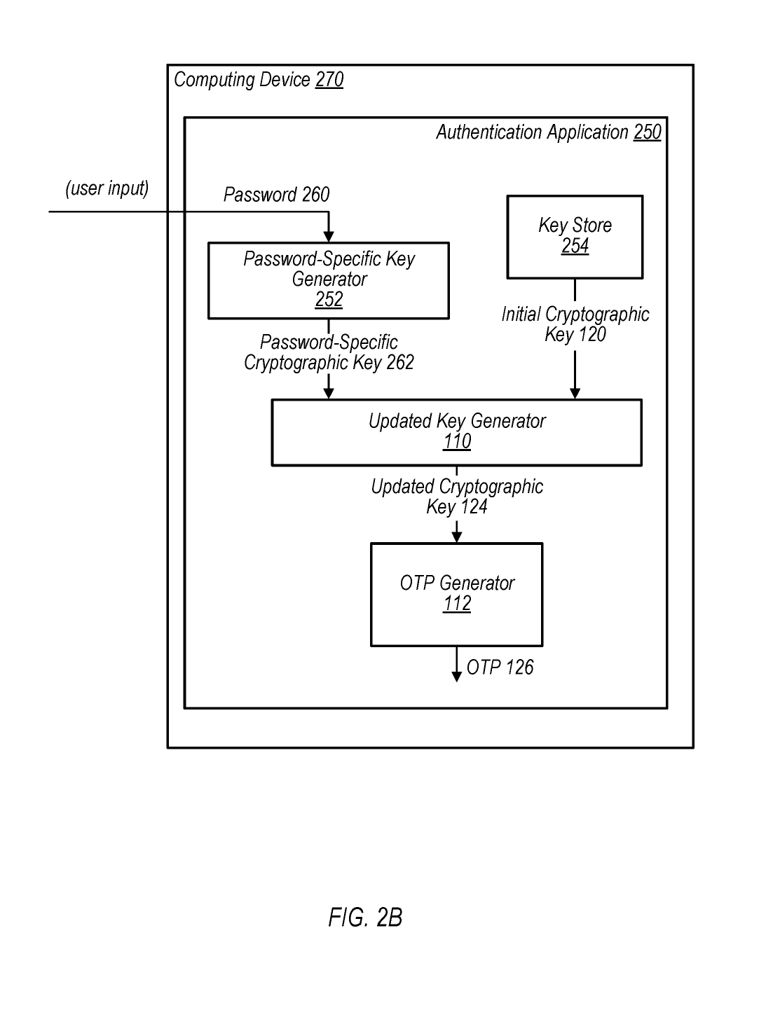

System 100 includes authentication application 104. In various embodiments, authentication application 104 may be operable to generate OTPs using an updated cryptographic key that is generated at the time of authentication. For example, as shown in FIG. 1, authentication application 104 includes updated key generator 110, which, in various embodiments, may be operable to generate an updated cryptographic key 124 at the time of authentication based on an initial cryptographic key 120 and a supplemental authentication data value 122. In some embodiments, initial cryptographic key 120 may be a cryptographic key (e.g., a symmetric key) that is shared by both the device on which authentication application 104 is executing and authentication server system 108. Further, the source of the supplemental authentication data value 122 may vary according to different embodiments. For example, as will be discussed in more detail with reference to FIG. 2A, supplemental authentication data value 122 may be a device-specific cryptographic key that is based on one or more attributes of the hardware or software elements of the computing device on which authentication application 104 is executing. In other embodiments, supplemental authentication data value 122 may be a password-specific cryptographic key that is based on a user-provided password, as will be discussed with reference to FIG. 2B.

Authentication application 104 further includes updated key generator 110. As will be explained in more detail below with reference to FIG. 2A, updated key generator 110 may be operable to generate updated cryptographic key 124 using various key-derivation techniques. Authentication application 104 further includes OTP generator 112, which may, in various embodiments, be operable to use the updated cryptographic key 124 to generate one or more OTPs 126, which may be provided to authentication server system 108 for validation. For example, in some embodiments, OTP generator 112 may use a time-based one-time passcode (TOTP) algorithm that computes OTPs 126 based on updated cryptographic key 124 and the current time. In other embodiments, however, any suitable OTP generation algorithm, such as a hash-based message authentication code (HMAC) OTP (HOTP) algorithm, may be used. Note that, in various embodiments, authentication application 104 may be executed either by client device 102 (as discussed with reference to FIG. 2A) or by a separate computing device accessible to the user of client device 102 (as discussed with reference to FIG. 2B).

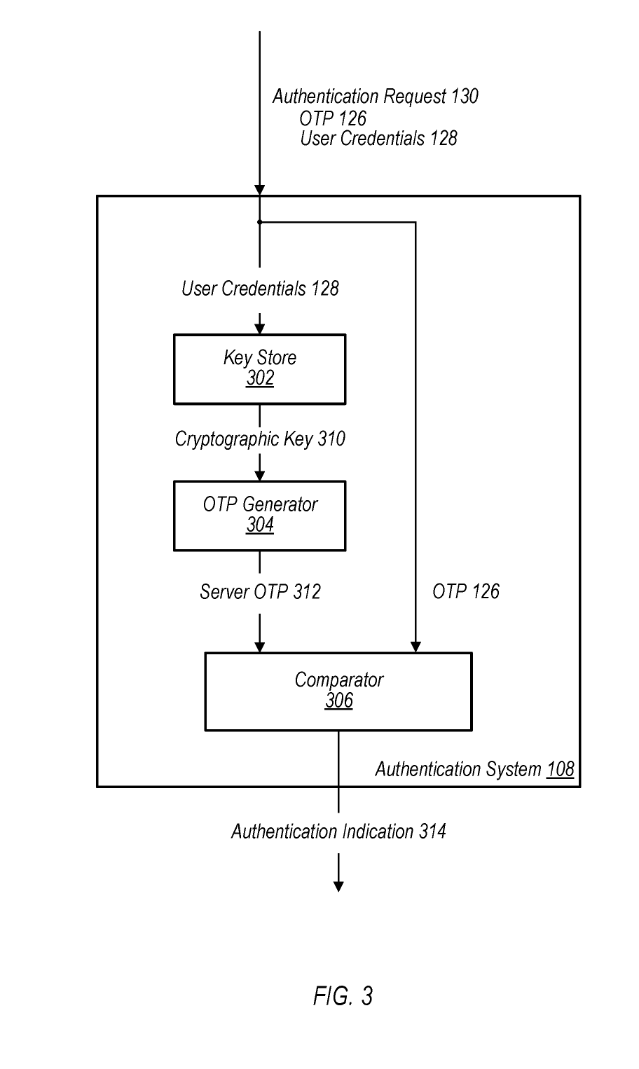

Once generated by authentication application 104, OTP 126 may be output such that client device 102 may send it, along with user credentials 128, to server system 106 for authentication. In various embodiments, server system 106 may delegate the process of authenticating the access requests that it receives (e.g., from client device 102) to authentication server system 108. In various embodiments, authentication server system 108 is a computer system that is operable to perform authentication operations for various services provided by various server systems. For example, in the embodiment depicted in FIG. 1, server system 106 sends an authentication request 130, including user credentials 128 and one or more OTPs 126, to authentication server system 108 for authentication. As will be discussed in more detail below with reference to FIG. 3, authentication server system 108 may be configured to determine whether to authenticate the user of client device 102 based on the OTP 126, and may send an authentication indication 132 to server system 106. This authentication indication 132 may indicate whether the user of client device 102 is authenticated to the service provided by server system 106, and server system 106 may determine whether to provide the requested service to the end user based on this authentication indication 132.

The present disclosure concerns technical problems in the field of user authentication. More specifically, the disclosed systems and methods, in at least some embodiments, address security concerns associated with storing cryptographic keys, used to generate OTPs for use in user authentication, on a client device. For example, consider an instance in which a client device is, unbeknownst to the user, compromised with malware capable of identifying sensitive authentication information (e.g., user credentials, stored cryptographic keys, etc.) and transmitting that information to an unauthorized user at a remote computer system. In an alternative system that does not utilize the disclosed systems or methods, the unauthorized user may be able to use this sensitive authentication information to generate valid OTPs and successfully pose as the authorized end user, accessing the service provided by server system 106. In various embodiments of the present disclosure, however, the unauthorized user would be unable to generate valid OTPs using this compromised information because, in at least some embodiments, the disclosed systems and methods use an updated cryptographic key 124, which is not retained in any permanent storage of the client device after authentication, to generate the valid OTPs 126. Further, in at least some embodiments, this updated cryptographic key 124 is not transmitted over the communication network. Accordingly, in various embodiments, the disclosed systems and methods prevent the unauthorized user from gaining unauthorized access to the service provided by server system 106 while posing as the user of client device 102. Thus, the disclosed systems and methods, in at least some embodiments, improve user authentication by securing the cryptographic keys used to generate OTPs, improving the user authentication process and the functioning of system 100 as a whole.

As noted above, supplemental authentication data value 122 may be obtained from various sources, according to various embodiments. The following discussion, with reference to FIGS. 2A and 2B, describes two particular embodiments of an authentication application obtaining supplemental authentication data and using that data to generate an updated cryptographic key. Note that these two particular embodiments are provided merely as examples and are not intended to limit the scope of the present disclosure.

Turning now to FIG. 2A, a block diagram illustrating an example authentication application 200 is shown, according to some embodiments. In various embodiments, authentication application 200 may correspond to authentication application 104 of FIG. 1 and be operable to generate updated cryptographic key 124 based on one or more device attributes of the device on which authentication application 200 is executing.

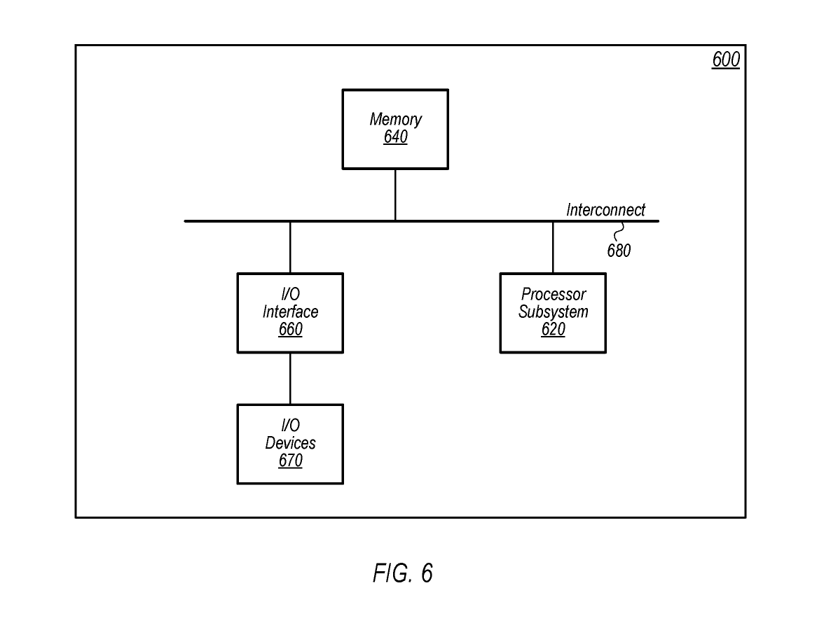

In FIG. 2A, client device 102 includes hardware elements 202 and software elements 204. As discussed in more detail below with reference to FIG. 6, hardware elements 202 may include any suitable combination of hardware subsystems, such as one or more processing units, system memory, user interface devices (e.g., a touchscreen), etc. For example, hardware elements 202 may include a non-transitory, computer-readable medium (e.g., a memory device) storing instructions that, when executed by one or more of the processing units, implements any suitable combination of software elements 204, such as system software (e.g., an operating system) or user application software (e.g., a web browser, authentication application 200, etc.).

As noted above, authentication application 104, in various embodiments, is configured to generate an updated cryptographic key 124 based on an initial cryptographic key 120 and a supplemental authentication data value 122. In the embodiment of FIG. 2A, the supplemental authentication data value 122 is a device-specific cryptographic key 222 that is based on one or more attributes of hardware elements 202 or software elements 204. For example, as shown in FIG. 2A, authentication application 200 includes device attribute determination module 206, which is operable to determine one or more device attributes associated with client device 102 and create a string 220 specifying those device attributes. For example, device attribute determination module 206 may be configured to identify one or more of the manufacturer of client device 102, operating system version, authentication application 200 version, type or size of system memory used, type of available I/O ports, screen resolution, or any other suitable hardware or software attribute. In some embodiments, device attribute determination module 206 may identify one or more of these attributes and combine that information to generate a string 220 that is particular to client device 102.

Authentication application 200 further includes device-specific key generator 208, which, in various embodiments, is operable to generate a device-specific cryptographic key 222 based on string 220. Device-specific key generator 208 may use any suitable key-derivation function in generating device-specific cryptographic key 222. For example, in various embodiments, device-specific key generator 208 may use Password-Based Key Derivation Function 2 (PBKDF2), Argon2, or any other suitable key-derivation function, including various hash-based algorithms, to generate device-specific cryptographic key 222.

FIG. 2A further includes key store 210. Key store 210 may store various keys (e.g., on a storage element of client device 102) for use in authentication operations for various services. As noted above, the disclosed systems and methods may be implemented to authenticate end users to various services provided by various server systems. Thus, in some embodiments, key store 210 may store cryptographic keys for use in user authentication with various services, and the appropriate key may be retrieved based on the service to which the authentication application 200 is attempting to authenticate. For example, in the embodiment of FIG. 2A, authentication application 200 may identify and retrieve an initial cryptographic key 120 that corresponds to the particular service provided by server system 106.

Authentication application 200 further includes updated key generator 110. In various embodiments, updated key generator 110 may generate updated cryptographic key 124 based on an initial cryptographic key 120 and supplemental authentication data, which, in the embodiment of FIG. 2A, is device-specific cryptographic key 222. In one embodiment, for example, updated key generator 110 may combine initial cryptographic key 120 and device-specific cryptographic key 222 using an exclusive OR (“XOR”) operation to generate updated cryptographic key 124. Note, however, that this embodiment is provided merely as an example and one of ordinary skill in the art with the benefit of this disclosure will recognize that other techniques for generating updated cryptographic key 124 based on initial cryptographic key 120 and device-specific cryptographic key 222 may be utilized. For example, any suitable logical algorithm may be utilized in combining initial cryptographic key 120 and device-specific cryptographic key 222 to generate updated cryptographic key 124. This updated cryptographic key 124, in turn, may be used by OTP generator 112 to generate one or more OTPs 126 for user authentication, as discussed above.

Thus, in the embodiment depicted in FIG. 2A, authentication application 200 is capable of generating an updated cryptographic key 124 that is specific to the client device 102 on which it was generated. Stated differently, the updated cryptographic key 124 of FIG. 2A—derived from the device-specific cryptographic key 222—is tightly coupled to client device 102. This property may provide various advantages to the user authentication process. For example, if authentication server system 108 can validate OTP 126 of FIG. 2A, generated by updated cryptographic key 124, this provides an extra measure of assurance that the OTP 126 was generated by the client device 102 belonging to the authorized user, rather than by an unauthorized user that was able to obtain initial cryptographic key 120.

Additionally, in some embodiments, authentication application 200 may perform various authentication operations shown in FIG. 2A (e.g., creating string 220, generating device-specific cryptographic key 222, generating OTP 126, etc.) without requiring user input. In such embodiments, authentication application 104 may be operable to automatically populate the OTP 126 in a service request sent to server system 106. Such embodiments may be particularly advantageous in instances in which the user is accessing the service provided by server system 106 via client device 102 (e.g., a laptop) so that authentication application 200 may perform continued authentication operations to keep the user authenticated to the service during a given user session. That is, these or other operations may be performed “in the background” of other operations (e.g., operations being performed by client device 102) such that a user of client device 102 may be unaware of the continued authentication operations taking place.

For example, such continued authentication operations may include generating, by authentication application 200, an updated OTP 126 after a particular time interval (e.g., 60 seconds since the last OTP 126 was sent) and providing that updated OTP 126 in an updated request to server system 106. In some embodiments, the frequency with which the updated OTPs 126 are sent to the server system 106 may vary based on a security preference of the user, the service, server system 106, or authentication server system 108. For example, for particularly sensitive services (e.g., banking software applications), updated OTPs 126 may be generated at a higher frequency (e.g., every 30 seconds). For less sensitive services (e.g., a social media website), OTPs 126 may be generated at a lower frequency (e.g., every 5 minutes). In various embodiments, such continued authentication operations may help ensure to authentication server system 108 and server system 106 the continued authentication of the user of client device 102 during the course of a user session, rather than simply once at the initiation of a user session.

Referring now to FIG. 2B, a block diagram illustrating another embodiment of an authentication application, authentication application 250, is shown. In various embodiments, authentication application 250 may correspond to authentication application 104 of FIG. 1 and be operable to generate updated cryptographic key 124 based on a password provided by a user at the time of authentication. That is, as noted above, authentication application 250 is operable to generate an updated cryptographic key 124 based on an initial cryptographic key 120 and a supplemental authentication data value 122, which, in the embodiment of FIG. 2B, is a password-specific cryptographic key 262 based on a user-provided password.

In FIG. 2B, authentication application 250 is shown executing on computing device 270. In some embodiments, computing device 270 (e.g., a smartphone) may be a separate computing device from the client device 102 (e.g., a laptop or desktop computer) via which the end user is accessing the service provided by server system 106. Note that this embodiment is provided merely as an example and, in other embodiments, authentication application 250 may be executed on client device 102 via which the user is accessing the service. In various embodiments, authentication application 250 may be configured to generate and display OTPs 126 to a user, allowing the user to provide the OTPs 126 to the server system 106 (e.g., by typing the OTP 126 into a web form sent to the server system 106).

For example, in one embodiment, when a user attempts to access the service provided by server system 106, the user may be prompted (e.g., via a web page) to provide user credentials and an OTP. The user may launch authentication application 250 and request that an OTP be generated. Authentication application 250 may then prompt the user to provide (e.g., via a touchscreen, keyboard, etc.) user input indicative of a password 260, such as an alphanumeric string or PIN code. As shown in FIG. 2B, authentication application 250 includes password-specific key generator 252, which, in various embodiments, is configured to generate a password-specific cryptographic key 262 based on password 260. Password-specific key generator 252 may use any suitable key-derivation function in generating password-specific cryptographic key 262. For example, in various embodiments, password-specific key generator 252 may use PBKDF2, Argon2, or any other suitable key-derivation function, including various hash-based algorithms, to generate password-specific cryptographic key 262. Further note that, in some embodiments, password 260 may correspond to a biometric reading of the user. For example, in one such embodiment, computing device 270 may include one or more biometric sensors (e.g., a fingerprint scanner, etc.), and the user may provide user input by using the one or more biometric sensors to generate a biometric reading, which may be used to generate password-specific cryptographic key 262.

FIG. 2B further includes key store 254, which, as noted above, may be configured to store various cryptographic keys for use in user authentication for various services. In FIG. 2B, authentication application 250 may identify and retrieve an initial cryptographic key 120 that corresponds to the particular service provided by server system 106. Further, authentication application 250 includes updated key generator 110, which is operable to generate updated cryptographic key 124 based on an initial cryptographic key 120 and supplemental authentication data, which, in the embodiment of FIG. 2B, is password-specific cryptographic key 262. This updated cryptographic key 124, in turn, may be used by OTP generator 112 to generate one or more OTPs 126 for user authentication, as discussed above.

Thus, in the embodiment depicted in FIG. 2B, authentication application 250 is capable of generating an updated cryptographic key 124 based on a user-provided password 260. In various embodiments, neither the user-provided password 260 nor the password-specific cryptographic key 262 are retained by the authentication application 250 or computing device 270 after the OTP 126 has been generated. Thus, even if an unauthorized user were to obtain the initial cryptographic key 120 that is retained by the authentication application 250, that unauthorized user would still be unable to successfully pose as the unauthorized user because the initial cryptographic key 120, by itself, cannot generate valid OTPs in various embodiments of the disclosed systems and methods. Thus, authentication application 250, in at least some embodiments, improves user authentication by securing the updated cryptographic key 124 used to generate OTPs 126.

As will be appreciated by of ordinary skill in the art with the benefit of this disclosure, aspects of authentication applications 200 and 250 may be combined in any suitable manner, in various embodiments. For example, in one embodiment, the supplemental authentication data value 122 may be based both on one or more device attributes and a user-provided password. In such an embodiment, authentication application 104 may, as described with reference to FIG. 2A, determine one or more device attributes associated with client device 102, create a string specifying those attributes, and perform a first cryptographic function on that string to generate a device-specific cryptographic key 222 based on that string. Further, authentication application 104 may, as described with reference to FIG. 2B, receive user input indicative of a user-provided password and perform a second cryptographic function on that password to generate a password-specific cryptographic key 262. Further, in such an embodiment, authentication application 104 may generate the updated cryptographic key 124 based on the initial cryptographic key 120, the device-specific cryptographic key 222, and the password-specific cryptographic key 262. For example, in one embodiment, authentication application 104 may generate the updated cryptographic key 124 by combining the initial cryptographic key 120, the device-specific cryptographic key 222, and the password-specific cryptographic key 262 using any suitable combination algorithm (including, e.g., an XOR operation). Further, in some such embodiments, the first and second cryptographic functions may be the same (e.g., PBKDF2, etc.).

Turning now to FIG. 3, a block diagram illustrating an example authentication server system 108 is depicted, according to some embodiments. In various embodiments, authentication server system 108 may be operable to determine whether to authenticate a user to a service provided by server system 106 based on one or more OTPs.

As shown in FIG. 3, authentication server system 108 may receive authentication request 130 from server system 106. For example, server system 106 may send authentication request 130 in response to a user of client device 102 attempting to access a service provided by server system 106. In various embodiments, authentication request 130 includes user credentials 128 and one or more OTP 126. In FIG. 3, authentication server system includes key store 302. As noted above, in various embodiments, authentication server system 108 and authentication application 104 may utilize pairs of keys as part of a cryptographic scheme to authenticate the user to the service provided by server system 106. Further, authentication server system 108 may, in various embodiments, perform authentication operations for various services, each of which may have numerous authorized users. Accordingly, in such embodiments, authentication server system 108 may store (e.g., in key store 302) keys associated with users of these various services.

In some embodiments, authentication server system 108 may use user credentials 128 to retrieve a cryptographic key 310 associated with the user for the particular service provided by server system 106. Authentication server system 108 further includes OTP generator 304, which, in various embodiments, is configured to generate server OTPs 312 based on cryptographic key 310. Note that, in various instances, authentication server system 108 may be less susceptible to compromise by an unauthorized user than client device 102. For example, client device 102 may be exposed to numerous sources of potential threat to which authentication server system 108 is not. In some instances, for example, a client device 102 may have various user applications installed thereon that would not be installed on authentication server system 108, presenting additional opportunities for malware to be introduced to the client device 102. Further, in instances in which client device 102 is a portable computing device, such as a smartphone or laptop, more people may have access to client device 102 than would have access to authentication server system 108. Accordingly, in various embodiments, rather than generating an updated cryptographic key at the time of authentication, the authentication server system 108 may simply store the cryptographic key 310 that corresponds to the updated cryptographic key 124 generated by authentication application 104. Note, however, that in some other embodiments, authentication server system 108 may instead store a key that corresponds to the initial cryptographic key 120 and a data value that corresponds to the supplemental authentication data value 122 of FIG. 1 and generate an updated cryptographic key (that matches updated cryptographic key 124) at the time of authentication.

Authentication server system 108 further includes comparator 306. In various embodiments, comparator 306 is operable to compare server OTP 312 with OTP 126 received from server system 106 and generate authentication indication 314. In various embodiments, authentication indication 314 may be expressed as a Boolean value, numeric value, or in any other suitable format that specifies the outcome of the comparison performed by comparator 306. Authentication indication 314 may, in various embodiments, be provided to server system 106 and may indicate whether the user is authenticated to the service. For example, in response to server OTP 312 matching OTP 126, authentication indication 314 may indicate that the user of client device 102 is authenticated to the service. If, however, server OTP 312 does not match OTP 126, authentication indication 314 may indicate that the user is not authenticated to the service, and server system 106 or authentication server system 108 may take one or more corrective actions, such as denying the user access to the service, prompting the user to provide an additional OTP 126, providing the user with a challenge question, etc.

Further note that, although server system 106 and authentication server system 108 are shown separately in FIG. 1, in various embodiments, server system 106 may be configured to perform some or all the functionality described with reference to authentication server system 108.

### Example Methods

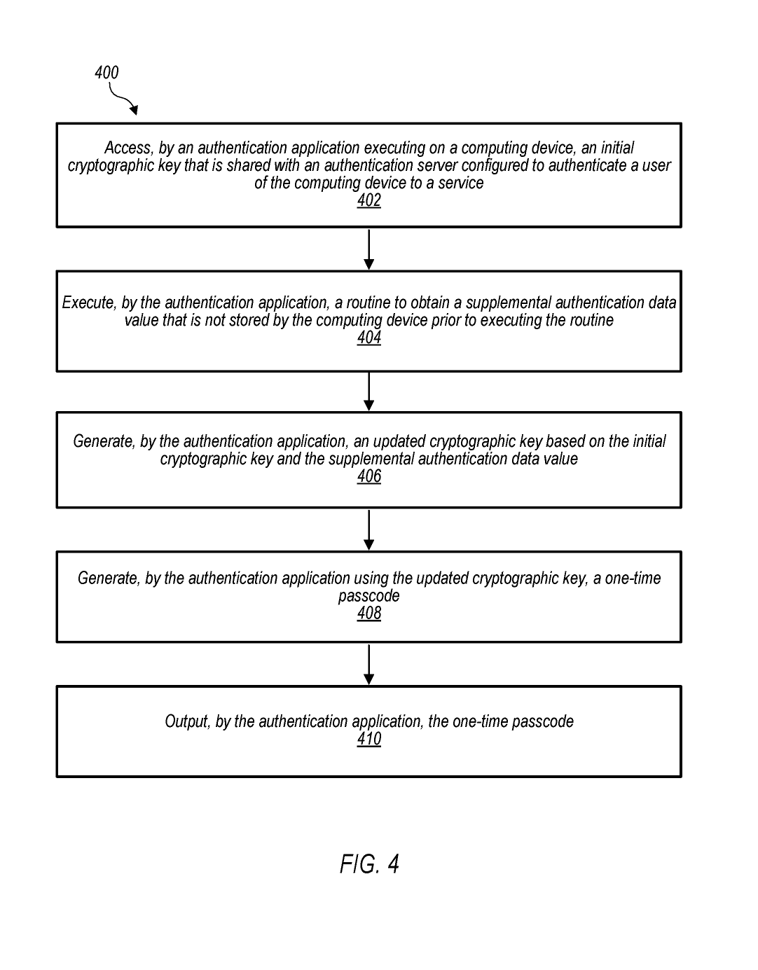

Referring now to FIG. 4, a flow diagram illustrating an example method 400 for generating a cryptographic key using supplemental authentication data is depicted, according to some embodiments. In various embodiments, method 400 may be performed, e.g., by authentication application 104 of FIG. 1, to authenticate a user of client device 102 to a service provided by server system 106.

In FIG. 4, method 400 includes elements 402-410. While these elements are shown in a particular order for ease of understanding, other orders may be used. In various embodiments, some of the method elements may be performed concurrently, in a different order than shown, or may be omitted. Additional method elements may also be performed as desired. Element 402 includes accessing, by an authentication application executing on a computing device, an initial cryptographic key that is shared with an authentication server configured to authenticate a user of the computing device to a service. For example, authentication application 104 may access initial cryptographic key 120, which is shared with authentication server system 108. In some embodiments, initial cryptographic key 120 may be a symmetric key that is specific to a service provided by server system 106.

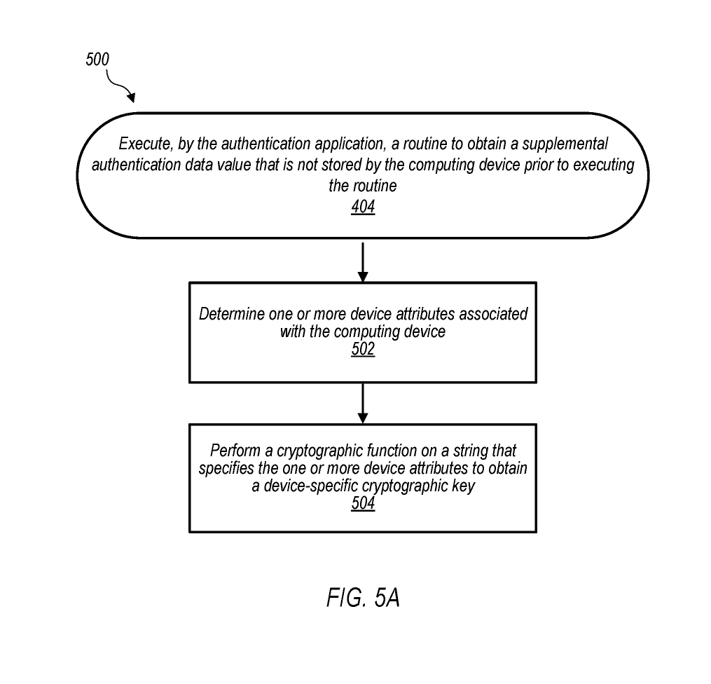

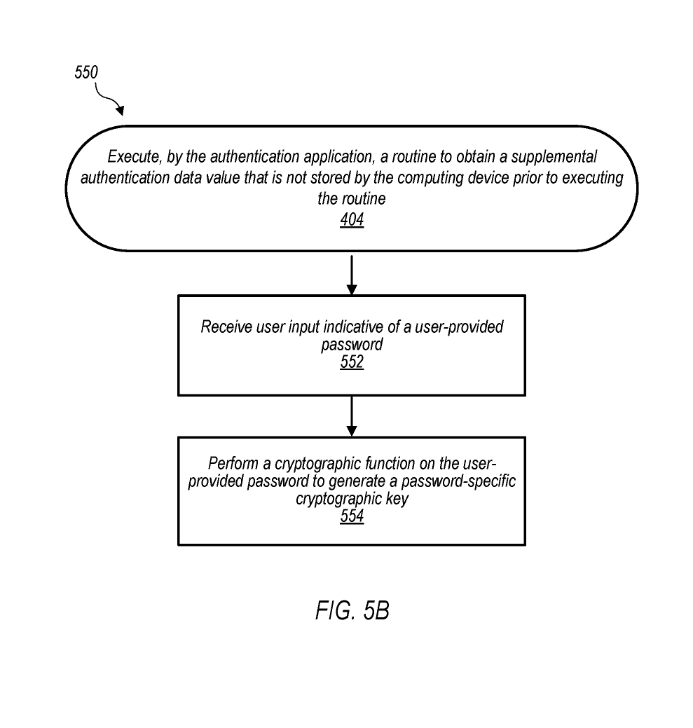

Method 400 then proceeds to element 404, which includes executing, by the authentication application, a routine to obtain a supplemental authentication data value that is not stored by the computing device prior to executing the routine. For example, as discussed in more detail below with reference to FIGS. 5A and 5B, the supplemental authentication data value may include a device-specific cryptographic key, a password-specific cryptographic key, etc.

Method 400 then proceeds to element 406, which includes generating, by the authentication application, an updated cryptographic key based on the initial cryptographic key and the supplemental authentication data value. For example, as discussed above with reference to FIG. 1, authentication application 104 may include an updated key generator 110 that is operable to generate an updated cryptographic key 124 based on the initial cryptographic key 120 and supplemental authentication data value 122.

Method 400 then proceeds to element 408, which includes generating, by the authentication application using the updated cryptographic key, a one-time passcode. As discussed above, OTP generator 112 may utilize any suitable OTP generation algorithm in generating OTP 126. For example, in one embodiment, generating OTP 126 may include implementing a time-based OTP algorithm using the updated cryptographic key 124, a time-based value, and a particular hash function.

Method 400 then proceeds to element 410, which includes outputting, by the authentication application, the one-time passcode. For example, authentication application 104 (whether executing on a separate computing device or on client device 102) may output OTP 126 such that client device 102 may send OTP 126 to server system 106 for authentication. In some embodiments, server system 106 may utilize authentication server system 108 to authenticate various end users to the services provided by server system 106. In such embodiments, the OTP may be usable by authentication server system 108 to authenticate the user of client device 102 to that service.

As discussed above, supplemental authentication data may be obtained from various sources, according to some embodiments. For example, element 404 of method 400 includes executing a routine to obtain supplemental authentication data that is not stored by the computing device prior to executing the routine. This supplemental authentication data may, in various embodiments, be used in generating a cryptographic key for use in user authentication. The following discussion, with reference to FIGS. 5A and 5B, describes two particular embodiments of element 404.

Turning to FIG. 5A, a flow diagram illustrating an example method 500 for executing a routine to obtain supplemental authentication data values is depicted, according to some embodiments. In various embodiments, method 500 may be performed, e.g., by authentication application 200 of FIG. 2A. In FIG. 5A, method 500 includes elements 502-504. While these elements are shown in a particular order for ease of understanding, other orders may be used. In various embodiments, some of the method elements may be performed concurrently, in a different order than shown, or may be omitted. Additional method elements may also be performed as desired.

Element 502 includes determining one or more device attributes associated with the computing device on which the authentication application is executing. For example, with reference to FIG. 2A, authentication application 200 may determine one or more attributes of hardware elements 202 or software elements 204, such as the year that client device 102 was manufactured, type of web browsing applications installed, manufacturer of processing elements, number of available I/O ports, or any other suitable hardware or software attribute.

Method 500 then proceeds to element 504, which includes performing a cryptographic function on a string that specifies the one or more device attributes to obtain a device-specific cryptographic key. For example, as noted above, device-specific key generator 208 of FIG. 2A may use any suitable key-derivation function in generating a device-specific cryptographic key 222. Note that, in various embodiments, information corresponding to the device attributes or the device-specific cryptographic key are not retained after outputting the OTP.

Referring now to FIG. 5B, a flow diagram illustrating an additional method 550 for executing a routine to obtain supplemental authentication data values is depicted, according to some embodiments. In various embodiments, method 550 may be performed, e.g., by authentication application 250 of FIG. 2B. In FIG. 5B, method 550 includes elements 552-554. While these elements are shown in a particular order for ease of understanding, other orders may be used. In various embodiments, some of the method elements may be performed concurrently, in a different order than shown, or may be omitted. Additional method elements may also be performed as desired.

Element 552 includes receiving user input indicative of a user-provided password. For example, with reference to FIG. 2B, authentication application 250 may receive user input (e.g., via a touchscreen, keyboard, etc.) indicative of a password 260. Method 550 then proceeds to element 554, which includes performing a cryptographic function on the user-provided password to generate a password-specific cryptographic key. For example, as noted above, password-specific key generator 252 of FIG. 2B may use any suitable key-derivation function in generating a password-specific cryptographic key 262. Note that, in various embodiments, information corresponding to the user-provided password or the password-specific cryptographic key are not retained after outputting the OTP.

### Example Computer System

Referring now to FIG. 6, a block diagram of an example computer system 600 is depicted, which may implement one or more computer systems, such as client device 102 or authentication server system 108 of FIG. 1, computing device 270 of FIG. 2B, etc., according to various embodiments. Computer system 600 includes a processor subsystem 620 that is coupled to a system memory 640 and I/O interfaces(s) 660 via an interconnect 680 (e.g., a system bus). I/O interface(s) 660 is coupled to one or more I/O devices 670. Computer system 600 may be any of various types of devices, including, but not limited to, a server system, personal computer system, desktop computer, laptop or notebook computer, mainframe computer system, server computer system operating in a datacenter facility, tablet computer, handheld computer, workstation, network computer, etc. Although a single computer system 600 is shown in FIG. 6 for convenience, computer system 600 may also be implemented as two or more computer systems operating together.

Processor subsystem 620 may include one or more processors or processing units. In various embodiments of computer system 600, multiple instances of processor subsystem 620 may be coupled to interconnect 680. In various embodiments, processor subsystem 620 (or each processor unit within 620) may contain a cache or other form of on-board memory.

System memory 640 is usable to store program instructions executable by processor subsystem 620 to cause system 600 perform various operations described herein. System memory 640 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 600 is not limited to primary storage such as system memory 640. Rather, computer system 600 may also include other forms of storage such as cache memory in processor subsystem 620 and secondary storage on I/O devices 670 (e.g., a hard drive, storage array, etc.). In some embodiments, these other forms of storage may also store program instructions executable by processor subsystem 620.

I/O interfaces 660 may be any of various types of interfaces configured to couple to and communicate with other devices, according to various embodiments. In one embodiment, I/O interface 660 is a bridge chip (e.g., Southbridge) from a front-side to one or more back-side buses. I/O interfaces 660 may be coupled to one or more I/O devices 670 via one or more corresponding buses or other interfaces. Examples of I/O devices 670 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 670 includes a network interface device (e.g., configured to communicate over WiFi, Bluetooth, Ethernet, etc.), and computer system 600 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In this disclosure, various “modules” configured to perform designated functions are shown in the figures and described in detail above (e.g., updated key generator 110, OTP generator 112, device attribute determination module 206, comparator 306, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
accessing, by an authentication application executing on a computing device, an initial cryptographic key that is shared with an authentication server configured to authenticate a user of the computing device to a service;
executing, by the authentication application, a routine to obtain a supplemental authentication data value that is not stored by the computing device prior to executing the routine, including by:
determining one or more device attributes associated with the computing device; and
generating the supplemental authentication data value based on the one or more device attributes;
generating, by the authentication application, an updated cryptographic key based on the initial cryptographic key and the supplemental authentication data value;
generating, by the authentication application using the updated cryptographic key, a one-time passcode that the authentication server is also configured to generate; and
outputting, by the authentication application, the one-time passcode, wherein the one-time passcode, when communicated to the authentication server, is usable by the authentication server to authenticate the user to the service.

2. The method of claim 1, wherein the supplemental authentication data value is a device-specific cryptographic key, wherein the generating the supplemental authentication data value comprises:
creating a string that specifies the one or more device attributes; and
performing a cryptographic function on the string to generate the device-specific cryptographic key.

3. The method of claim 2, wherein at least one of the one or more device attributes corresponds to a manufacturer of the computing device.

4. The method of claim 1, wherein the computing device is a mobile communication device, wherein outputting the one-time passcode includes causing the one-time passcode to be depicted by a display of the mobile communication device, and wherein the one-time passcode is usable to be provided to the authentication server for authentication.

5. The method of claim 1, wherein the service is provided to the user, by a server system, via the computing device; and wherein outputting the one-time passcode includes automatically populating the one-time passcode in a service request sent to the server system.

6. The method of claim 5, further comprising:
performing, by the authentication application, continued authentication operations to keep the user authenticated to the service during a given user session, wherein an instance of the continued authentication operations include:
generating, by the authentication application using the updated cryptographic key, an updated one-time passcode after a particular time interval; and
providing the updated one-time passcode in an updated request sent to the server system.

7. A method, comprising:
accessing, by an authentication application executing on a computing device, an initial cryptographic key that is shared with an authentication server configured to authenticate a user of the computing device to a service;
executing, by the authentication application, a routine to obtain a supplemental authentication data value that is not stored by the computing device prior to executing the routine, including by:
receiving user input indicative of a user-provided password; and
performing a cryptographic function on the user-provided password to obtain the supplemental authentication data value;
generating, by the authentication application, an updated cryptographic key based on the initial cryptographic key and the supplemental authentication data value;
generating, by the authentication application using the updated cryptographic key, a one-time passcode that the authentication server is also configured to generate; and
outputting, by the authentication application, the one-time passcode, wherein the one-time passcode, when communicated to the authentication server, is usable by the authentication server to authenticate the user to the service.

8. The method of claim 7, wherein the supplemental authentication data value is a password-specific cryptographic key; wherein the password-specific cryptographic key is not retained by the authentication application after the outputting the one-time passcode.

9. The method of claim 7, wherein the computing device is a mobile communication device; and wherein outputting the one-time passcode includes causing the one-time passcode to be depicted by a display of the mobile communication device, and wherein the one-time passcode is usable to be provided to the authentication server for authentication.

10. The method of claim 7, wherein the service is provided to the user, by a server system, via the computing device; and wherein outputting the one-time passcode includes automatically populating the one-time passcode in a service request sent to the server system.

11. A method, comprising:
accessing, by an authentication application executing on a computing device, an initial cryptographic key that is shared with an authentication server configured to authenticate a user of the computing device to a service;
executing, by the authentication application, a routine to obtain a supplemental authentication data value that is not stored by the computing device prior to executing the routine;
generating, by the authentication application, an updated cryptographic key based on the initial cryptographic key and the supplemental authentication data value;
generating, by the authentication application using the updated cryptographic key, a one-time passcode that the authentication server is also configured to generate; and
outputting, by the authentication application, the one-time passcode, wherein the one-time passcode, when communicated to the authentication server, is usable by the authentication server to authenticate the user to the service.

12. The method of claim 11, wherein the supplemental authentication data value is a device-specific cryptographic key.

13. The method of claim 12, wherein the executing the routine to obtain the supplemental authentication data value comprises:
determining, by the authentication application, one or more device attributes associated with the computing device; and
performing, by the authentication application, a cryptographic function on a string that specifies the one or more device attributes to obtain the device-specific cryptographic key.

14. The method of claim 11, wherein the supplemental authentication data value is a password-specific cryptographic key; and wherein the executing the routine to obtain the supplemental authentication data value comprises:
receiving user input indicative of a user-provided password; and
performing a cryptographic function on the user-provided password to generate the password-specific cryptographic key.

15. The method of claim 11, wherein the executing the routine to obtain the supplemental authentication data value comprises:
determining one or more device attributes associated with the computing device;
performing a first cryptographic function on a string that specifies the one or more device attributes to obtain a device-specific cryptographic key;
receiving user input indicative of a user-provided password; and
performing a second cryptographic function on the user-provided password to generate a password-specific cryptographic key.

16. The method of claim 15, wherein the generating the updated cryptographic key includes combining the initial cryptographic key, the device-specific cryptographic key, and the password-specific cryptographic key.

17. The method of claim 15, wherein the first and second cryptographic functions are the same.

18. The method of claim 11, wherein the computing device is a mobile communication device; and wherein outputting the one-time passcode includes causing the one-time passcode to be depicted by a display of the mobile communication device, and wherein the one-time passcode is usable to be provided to the authentication server for authentication.

19. The method of claim 11, wherein the service is provided to the user, by a server system, via the computing device; and wherein outputting the one-time passcode includes automatically populating the one-time passcode in a request sent to the server system.

20. The method of claim 11, wherein the generating the one-time passcode includes implementing a time-based one-time password (TOTP) algorithm using the updated cryptographic key, a time-based value, and a particular hash function.
